(19) United States
(12) Patent Application Publication
(10) Pub. No.: US 2025/0381714 A1
(43) Pub. Date: Dec. 18, 2025

(54) DEVICE AND METHOD FOR INJECTION MOLDING OF COMPLEX PLASTIC PRODUCTS

(71) Applicant: FOBOHA (Germany) GmbH, Haslach (DE)

(72) Inventor: Rainer Armbruster, Wolfach (DE)

(21) Appl. No.: 18/878,304

(22) PCT Filed: Jun. 28, 2023
(86) PCT No.: PCT/EP2023/067597

§ 371 Date: Dec. 23, 2024

(30) Foreign Application Priority Data
Jun. 29, 2022 (DE) 10 2022 116 243.5

(51) Int. Cl. B29C 45/16; B29C 45/06

(52) U.S. Cl. CPC B29C 45/1628; B29C 45/06

(57) ABSTRACT

An injection-molding device (1) for injection molding of plastic material includes a first mold half (2) and a second mold half (3), displaceable with respect to each other in a first direction (x) between an open position and a closed position. A center part (4) comprises an around a rotation axis (5) rotatable center block (6) with at least one pair of opposite side faces (7) each comprising at least one inner cavity half (8), which in the open position is rotatably arranged in steps of 90° around the rotation axis (5) between the first mold half (2) and the second mold half (3). They side faces alternate between an aligned position (11 and a lateral position (12 A drive unit (14) is configured to interact with the displaceable cavity section (13) arranged in the lateral position to move the displaceable cavity section (13) from a first position into a second position.

### FIELD OF THE DISCLOSURE

The present disclosure is in the field of devices and methods for injection molding of complex plastic products and thereto related auxiliary devices.

### BACKGROUND OF THE DISCLOSURE

WO20025361A1, first published in February 2020 on behalf of the same applicant, is directed to injection molding device comprising a center part and a rotating device for rotating the center part in the injection-molding device. The rotating device comprises a base supported with respect to an injection-molding machine. A thereto-attached column extends in an axial direction above the base. A sleeve coaxially surrounds the column and being at least partially arranged in the center part. The sleeve rotates with the center part around the column. The column is arranged removable with respect to the center part.

WO18234504A1, first published in December 2018 on behalf of the same applicant, is directed to a device for the injection molding and blow molding of parts, in particular hollow bodies made of a plurality of plastic components. The center part has lateral surfaces arranged in pairs with respect to each other, which are arranged relative to each other with rotational symmetry with respect to the axis of rotation of the rotatable center part. In a closed position of the device they interact in the region of a first, a second and a third parting plane with corresponding arranged outer surfaces of the first, the second and the third mold halves in order to form at least one first, one second and one third mold cavity. At least one first mold cavity is used to form a first plastic component. At least one second mold cavity is used to form a second plastic component. At least one third mold cavity is used to shape a first and/or a second plastic component arranged therein by blow molding.

US2004094866A2 was first published in May 2005 on behalf of Boutech NV. It is directed to a method for manufacturing injection molding pieces consisting of at least two components. A first injection-molding piece is formed of a first component in a first mold impression and a second injection-molding piece is formed by putting the first injection-molding piece in a second mold impression by providing a second component on it. A mold with at least three series of mold parts is used. The first series and the second series thereof alternately work in conjunction with the third series and whereby a mutual repositioning of every first injection-molding piece takes place in between. The molds are arranged in a rotary manner.

WO2014075883A1, first published in May 2014 on behalf of Krauss Maffei Technologies GmbH relates to a turning module for an injection-molding machine for producing a molded part. A turning device is rotatable about at least a first axis of rotation on the turning module, wherein a rotating device is arranged on at least one turning surface and is rotatable about a second axis of rotation.

CH708141A2, first published in December 2014 on behalf of the same applicant, relates to an injection-molding device. The injection-molding device includes a first mold half and a second mold half, which is arranged so that the second mold half can be moved linearly in relation to the first mold half. A third mold half, arranged between the first and the second mold halves, interacts with the first mold half in a first parting plane to form first cavities and interacts with the second mold half on a second parting plane to form second cavities. The third mild half includes an upper part and a lower part, spaced apart by a slot. A first drive shaft is arranged in an interior on the third mold half. The first dive shaft includes at least one carried arranged on an arm so that the carrier is movable in a radial direction. The first drive shaft is supported with respect to both the upper part and the lower part by at least one bearing.

AT520478B1, first published in February 2021 on behalf of Niigon Machines Ltd., relates to an injection-molding machine with rotary apparatus. The injection-molding machine includes a stationary platen and a moving platen mounted on a machine base, and a rotary apparatus for rotatably supporting a center mold section. The rotary apparatus includes a carriage body including a carriage upper portion supported by first and second carriage rails, and a carriage lower portion extending downward from the carriage upper portion laterally intermediate the first and second carriage rails. The rotary apparatus further includes a rotary table mounted atop the carriage body for rotatably supporting the center mold section. The rotary table is mounted to the carriage body by a rotary table bearing having a combination of bearing elements to bear axial, rotational, and moment loads. The machine further includes a plurality of tie bars extending between the moving platen and the stationary platen. The tie bars are free from engagement by the rotary apparatus.

U.S. Pat. No. 10,603,828B2, first published in March 2020 on behalf of the Procter & Gamble Company, relates to an injection-molding device. The injection-molding device has a first mold half, an index plate that in a molding position is at least partly received in the first mold half, and an index plate axle connected with the index plate. The index plate axle is arranged for linear movement along its longitudinal axis relative to the first mold half so that the index plate can be moved between the molding position and a turning position in which the index plate can be rotated with respect to the first mold half. An adaptor plate, connected to the first mold half, has a drive and a first coupling element coupled with the drive. The first coupling element is arranged eccentric with respect to the longitudinal axis of the index plate axle.

US2006244178A1, first published in November 2006 on behalf of the same applicant, relates to a device for injection molding. The device comprising a first fixed half-mold and a second half-mold mobile in direction of the side blocks of an injection-molding machine. Between the first and the second half-molds are mounted first and second intermediate elements mobile in the direction of the side blocks. The first and the second intermediate elements comprise each a mold support pivoting relative to a base about pivoting axis. Centering elements are used to center the intermediate elements relative to the half-molds upon the opening and closure on the injection-molding device.

WO2013067636A1, first published in May 2013 on behalf of Husky Injection Molding Systems Ltd., relates to a mold function actuator. The mold function actuator is mountable to one of a stationary platen or a movable platen of a mold clamp. The mold function actuator includes a driving member, which is configured to rotatably engage a first driven member of a mold for driving a mold function.

### SUMMARY OF THE DISCLOSURE

Injection molding of complex parts made from several components of plastic material is often subject to limitations when the complexity of the parts gets to a certain level. One object of the present disclosure is to be able to produce complex parts, e.g. comprising several material components, by injection molding in a more efficient manner in a single injection-molding device. A further object of the present disclosure is to provide a drive unit for such an injection-molding device. Preferably, said drive unit is attached in a modular fashion to the outside of the injection-molding device in a position where it is easily accessible.

An injection-molding device according to the present disclosure is suitable to make multi-component plastic products by injection molding of several components of plastic material in a single device. The injection-molding device usually comprises a first (outer) mold half and a second (outer) mold half, displaceable with respect to each other in a first direction between an open position and a closed position. A center part is arranged between the first and the second mold half. It comprises an around a rotation axis rotatable center block with at least one pair of—with respect to the rotation axis—opposite side faces.

In the closed position, one pair of side faces is in an aligned position and engaged with corresponding side faces of the first and the second mold half in a first and a second mold parting line. The other pair of side faces are in a lateral position and usually accessible from the outside. The center block is preferably held in an injection-molding machine by a holding device. The holding device usually comprises an upper bearing block arranged above the center block and a lower bearing block arranged below the center block, which is arranged between them. If appropriate, a coordination device is present that interconnects the first and the second mold half and the center part, making sure that the center part is positioned in the center between the first and the second mold half in the first direction. A rotation axis of the center block is usually arranged perpendicular to the first direction, preferably vertically. Each side face of the center block comprises at least one inner cavity halve. The inner cavity halves are usually arranged in pairs with respect to each other and with rotational symmetry with respect to the rotation axis of the rotatable center block. In the open position, the center block is rotatable in steps of 90° around the rotation axis between the first mold half and the second mold half. The inner cavity halves, on their travel around the rotation axis, are alternating between a so-called aligned position in and a so-called lateral position. In the aligned position, the inner cavity halves are aligned with the first and the second mold halves forming in the closed position of the injection molding device, cavities with corresponding (similar or different) outer cavity halves arranged at the first and the second mold halves. The cavities are configured to receive during production in the closed position in each cycle at least one component of liquefied plastic material to form a product thereof after curing of the material. In the lateral position, the inner cavity halves are arranged laterally from the first and the second mold halves at a 90° position with respect to the first direction, thereby being accessible from the outside. The first and the second mold halves are during operation usually attached to a first mold holding plate and a second mold holding plate of an injection-molding machine. The first and the second mold holding plate being displaceable with respect to each other in the first direction along tie bars usually forming part of the injection-molding machine.

The at least one inner cavity half preferably comprises at least one in at least one direction displaceable cavity section as described in more detail hereinafter. The injection-molding device further comprises a drive unit, which is configured to interact directly or indirectly, preferably in the closed position of the injection-molding device with the displaceable cavity section arranged in the lateral position, being accessible from the outside, to move the displaceable cavity section from a first position into a second position. Thereby it becomes possible to transfer an intermediate part made in a previous injection-molding step from one cavity to another in which it is e.g. overmolded by the same or a different material/color. The drive unit is preferably arranged in a stationary manner with respect to the first or the second mold half. It preferably engages mechanically with the displaceable cavity section by a linear displacement in the first or a thereto transversal relative movement.

In a preferred variation, the at least one displaceable cavity section is arranged rotatable with respect to the side face of the center block in which it is arranged. The displaceable cavity section may be arranged on a turntable rotatable around a respective rotation axis preferably arranged perpendicular with respect to the side face of the center block in which the turntable is arranged. If appropriate, the displaceable cavity section may be arranged in addition displaceable with respect to the turntable to produce parts that are even more complex. Thereby it is possible to set the parts free when moved from one cavity to another. Good results can be achieved when the displaceable cavity section is actuated by at least one actuation finger arranged at and protruding from the center block, e.g. in that the actuation finger displaces the displaceable cavity when the rotatory table is linearly moved in the direction of the rotation axis.

The turntable may comprise a first gear configured to interconnect with a corresponding second gear of the drive unit. The interconnection can be established e.g. during closing of the mold or by a relative movement of the first gear with respect to the second gear in direction of the rotation axis. The first and the second gear are preferably straight-toothed gears. Depending on the field of application, other type of clutches are possible. Good results can be achieved when the turntable is arranged on a platform, which is linearly displaceable in the direction of the rotation axis. The platform is preferably arranged in or forming part of a side face of the center block. Linear guiding means can be foreseen which allow to lift the platform of the side face of the center block. For lifting of the platform, hydraulic, pneumatic, or electric actuators or a combination thereof can be integrated into the center block. If appropriate, two or more turntables can be arranged in a side face, respectively or a platform adjacent to each other. The turntable can interact with each other by circumferential gears, which engage with each other directly or indirectly, such that the rotation of a first turntable is transmitted to a neighboring second turntable that rotates in the same direction or counter clock wise when directly interconnected. If appropriate, the displaceable cavity section may be arranged displaceable perpendicular to the respective side face of the center block. In a preferred variation, the drive unit for the turntable is arranged in a fixed manner with respect to the first mold half or the second mold half.

A preferred variation of a drive unit according to the present disclosure is at least partially arranged on the outside of at least one mold half and being mechanically interconnected to at least one moveable device arranged at the at least one mold half to actuate said device. The drive unit usually comprises a motor and a gearbox which preferably are arranged on the outside of the at least one mold half. The motor and the gearbox can be arranged on a platform. The drive unit can be attached by a bracket to a tie bar of an injection molding device machine as described in more detail hereinafter. The drive unit can be attached directly to the first or the second mold half and/or to at least one of the tie bars of the injection molding machine as mentioned above. In a preferred variation, the drive unit consists of a motor and a thereto-interconnected gearbox, which form a compact unit. Good results can be achieved, when the gearbox is of an angular type, which offers a space saving arrangement. The compact unit is preferably arranged on the outside of the first and/or the second mold half such that it remains accessible, e.g. from a lateral side of the injection mold, although the injection molding device is in a closed position. Depending on the field of application, the drive unit can be used to actuate other elements in molds, which have a single parting line and do not comprise a center block. The drive unit can e.g. be used to actuate a turntable in an injection mold arranged in a closed position between a first and a second mold half. If appropriate, the drive unit can be arranged on a platform spaced a distance apart from a lateral side of the mold half. If not arranged on the movable side of the injection mold, the drive unit can be attached by a bracket to a tie bar of the injection-molding machine. The drive unit should thus be considered a separate inventive concept, which may be made subject of one or several divisional patent applications.

A method for the production of complex plastic products with an injection-molding device according to the present disclosure normally comprises the following method steps:
(a) Closing the injection-molding device by relative movement in the first direction along the tie bars such that between the first mold half and a thereto in the first direction aligned first side face of the center block at least one first cavity is established. The first cavity is established by at least one first outer cavity half and at least one thereto corresponding first inner cavity half. Simultaneously second cavities are established between the second mold half and a thereto in the first direction aligned second side face of the center block. The at least one second cavity is established by at least one second outer cavity half and at least one second inner cavity half.
(b) Injecting liquefied plastic material into the first and the second cavity to form first and second parts.
(c) Opening the injection-molding device and rotating the center part by 90° such that the first inner cavities and the therein arranged first parts are moved from the aligned position to a lateral position with respect to the rotation direction arranged at 90° to the first mold half. Simultaneously the second inner cavities and the therein arranged second parts are moved to a lateral position arranged at 90° with respect to the second mold half.
(d) Closing the injection-molding device and injecting plastic material as described above.
(e) In the lateral position, on the side face where the first parts are arranged in the first inner cavities, interconnecting the drive unit with the at least one displaceable cavity section and moving the first parts from the first inner cavities to the second inner cavities by displacing the displaceable inner cavity section. Simultaneously in the lateral position, on the side face where the second parts are arranged in the second inner cavities, removing the second parts from the second inner cavities.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described disclosure will be more fully understood from the detailed description given herein below and the accompanying drawings, which should not be considered limiting to the disclosure described in the appended claims. The drawings are showing:

FIG. 1A variation of the injection molding device in a closed position;

FIG. 2 Detail A of FIG. 1;

FIG. 3 The injection molding device according to FIG. 1 in an open position;

FIG. 4 The injection molding device according to FIG. 1 in a reduced manner;

FIG. 5 Detail B of FIG. 5;

FIG. 6A variation of a drive unit;

FIG. 7 Several positions of a drive unit with respect to a cube mold;

FIG. 8 Several positions of a drive unit with respect to a single face mold.

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

FIG. 1 shows a first variation of an injection-molding device 1 according to the present disclosure in a perspective view from the front and above. The injection molding device 1 comprises a first mold half 2, a second mold half 3 and a there between arrange center part 4. The center part comprises an around a rotation axis 5 rotatable center block 6. The center block 6 is held by a holding device 24 comprising an upper bearing block 25 arranged above the center block 6 and a lower bearing block 26 arranged below the center block 6.

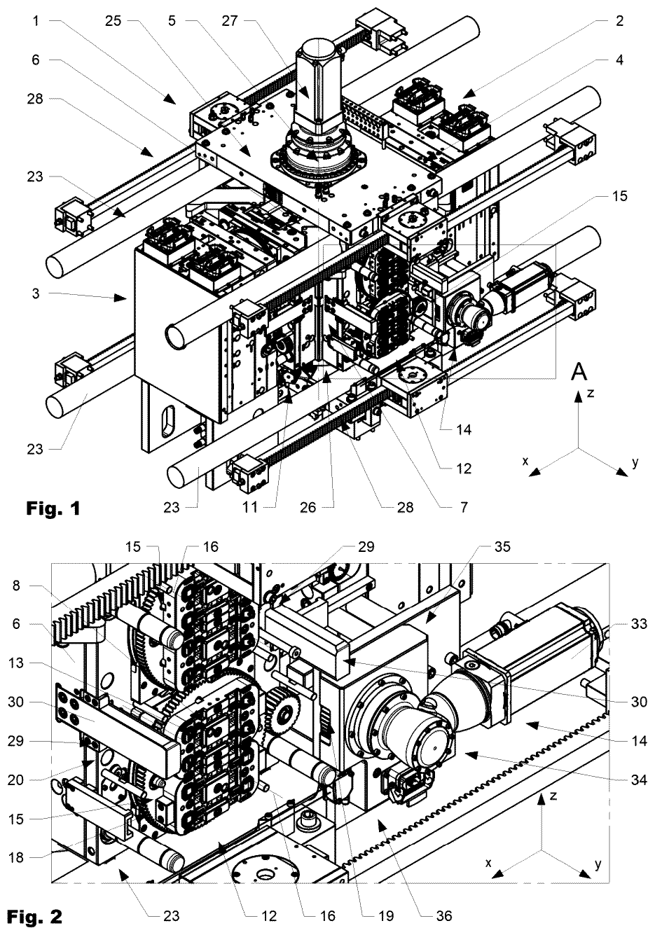

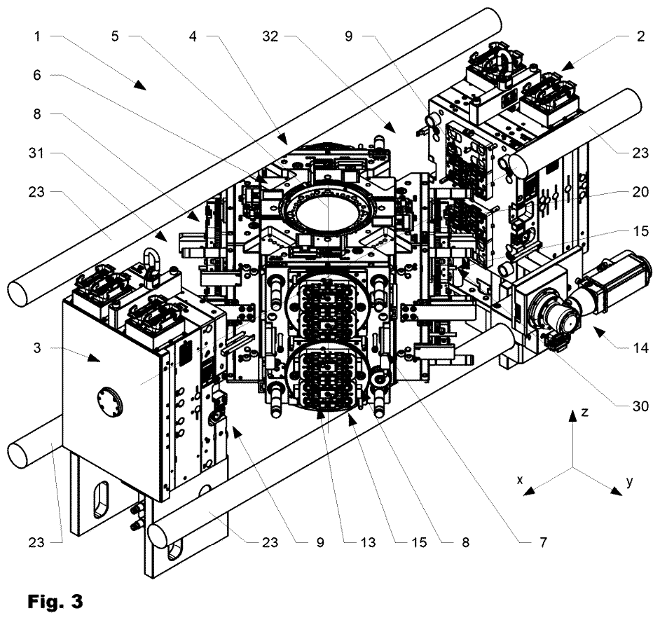

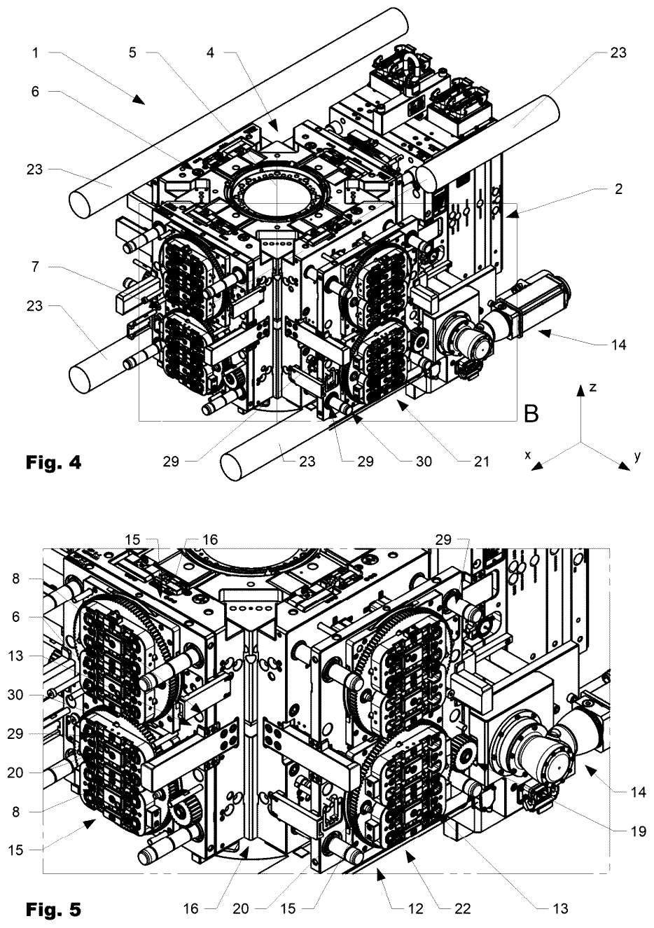

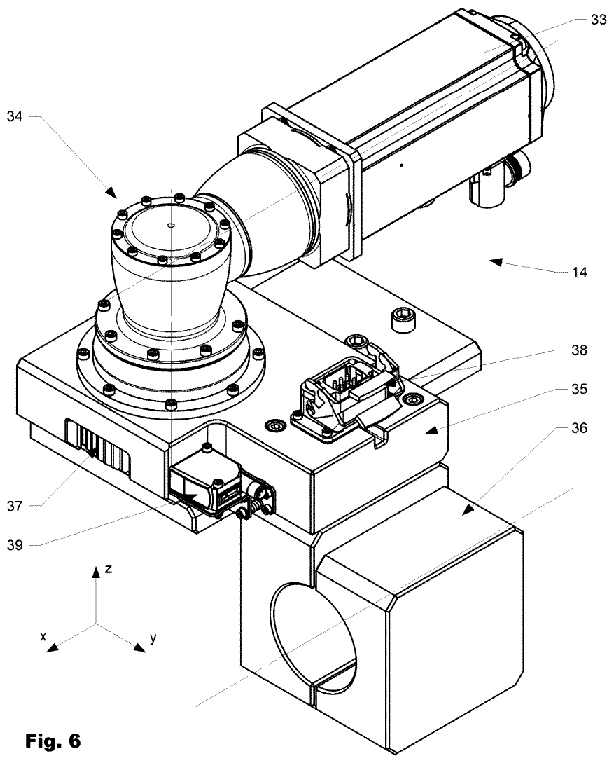

The first mold half 2, the second mold half 3 and the there-between arranged center part 4 are displaceable with respect to each other in a first direction x between an open position as visible in FIG. 1 and a closed position as visible in FIG. 3. FIG. 2 is showing detail A of FIG. 1 in a magnified manner. FIG. 4 is showing for better visibility and understanding the injection molding device 1 according to FIG. 1 without the second mold half 3 and the holding device 24. FIG. 5 is showing detail B of FIG. 4 in a magnified manner.

The first and the second mold halves 2, 3 are during operation usually attached to a first mold holding plate (not shown) and a second mold holding plate (not shown) of an injection molding machine (not shown). The first and the second mold holding plate being displaceable with respect to each other in the first direction along tie bars 23, schematically shown in the drawings, usually forming part of the injection-molding machine. A coordination device 28 interconnects the first mold half 2 and the second mold half 3 and the center part 4. It ensures that the center part 4 remains in the middle between first and the second mold halves 2, 3.

The center block 6 comprises in the shown variation two pairs of opposite side faces 7. Each comprising at least one inner cavity half 8. The center block 6, respectively the inner cavity halves 8, and the first and the second mold halves 2, 3 interact with each other in a first parting line 31 and a second parting line 32. The inner cavity halves are in the open position rotatable in steps of 90° around the rotation axis 5 between the first mold half 2 and the second mold half 3. They are thereby alternating between an aligned position 11, forming in the closed position (FIG. 1) cavities 10 with corresponding outer cavity halves 9 arranged at the first mold half 2 and the second mold half 3, and a lateral position 12 accessible from the outside when in the closed position. In FIG. 3 the center block is shown half way turned at a rotation angle of 45°. The at least one inner cavity half 8 comprises at least one displaceable cavity section 13 as will be described in more detail hereinafter. A drive unit 14 is configured to interconnect with the displaceable cavity section 13 when arranged in the lateral position 12 to move the displaceable cavity section 13 from a first position into a second position, e.g. by a linear and/or a rotary movement.

In the shown variation the at least one displaceable cavity section 13 is arranged rotatable with respect to the side face 7 of the center block 6 in which it is arranged. The displaceable cavity section 13 is arranged on a turntable 15 rotatable around a rotation axis 16 extending here perpendicular to the respective side face of the center block 6. In addition, the displaceable cavity section 13 is arranged displaceable with respect to the turntable 15. Thereby complex parts may be manufactured as complex cavities become possible. The displaceable cavity section 13 is in the shown variation actuated by at least one actuation finger 17 arranged at the center block 4. Depending on the design, other types of actuators can be foreseen.

The turntable 15 of the shown variation furthermore comprises a first gear 18 to interconnect to a second gear 19 of the drive unit 14 when engaged in the lateral position as shown in FIG. 4. As it can be seen, the turntable 15 is with respect to the center block 6 arranged linearly displaceable in the direction of the rotation axis 16 between a dorsal position 21 and a distal position 22 best visible in FIG. 4. The turntable 15 is arranged on a platform 20, which is arranged linearly displaceable in the direction of the rotation axis 16, i.e. perpendicular to the respective side face 7. In the shown variation, two turntables 15 are arranged on a platform 20 adjacent and with respect to the drive unit interconnected to each other. In the shown variation, the drive unit 14 is arranged in a fixed manner with respect to the first mold half 2 or the second mold half 3.

In the shown variation, the drive unit 14 is attached directly to the first mold half and by a bracket 35 to the lower tie bar 23 shown in the front of the drawing. The drive unit 14 consists of a motor 33 and a thereto interconnected gearbox 34. The motor 33 and the gearbox 34 together form a compact unit, which is arranged on the outside of the first mold half such that it remains accessible from lateral. If appropriate, the drive unit can be used to actuate other elements in the injection-molding device as shown.

A method for the production of complex plastic products with an injection-molding device 1 according to the present disclosure normally comprises the following method steps:
(a) Closing the injection-molding device 1 along the first and the second parting line 31, 32 by relative movement of the first and the second mold halves 2, 3 and the in between them arranged center part 4 in the first direction along the tie bars 23. Thereby, between the first mold half 2 and a thereto in the first direction aligned first side face 7 of the center block 6 at least one first cavity is established. The first cavity is established by at least one first outer cavity half and at least one thereto corresponding first inner cavity half. Simultaneously second cavities are established between the second mold half and a thereto in the first direction aligned second side face of the center block 6. The at least one second cavity is established by at least one second outer cavity half and at least one second inner cavity half.
(b) Injecting liquefied plastic material into the first and the second cavity to form first and second parts.
(c) Opening the injection-molding device 1 and rotating the center part 4 by 90° such that the first inner cavities and the therein arranged first parts are moved from the aligned position to a lateral position with respect to the rotation direction arranged at 90° to the first mold half. Simultaneously the second inner cavities and the therein arranged second parts are moved to a lateral position arranged at 90° with respect to the second mold half.
(d) Closing the injection-molding device 1 and injecting plastic material as described above.
(e) In the lateral position at 90°, respectively 270°, on the side face where the first parts are arranged in the first inner cavities, interconnecting the drive unit 14 with the at least one displaceable cavity section 13 and moving the first parts from the first inner cavities to the second inner cavities by displacing the displaceable inner cavity section. Simultaneously in the lateral position, on the side face where the second parts are arranged in the second inner cavities, removing the second parts from the second inner cavities.

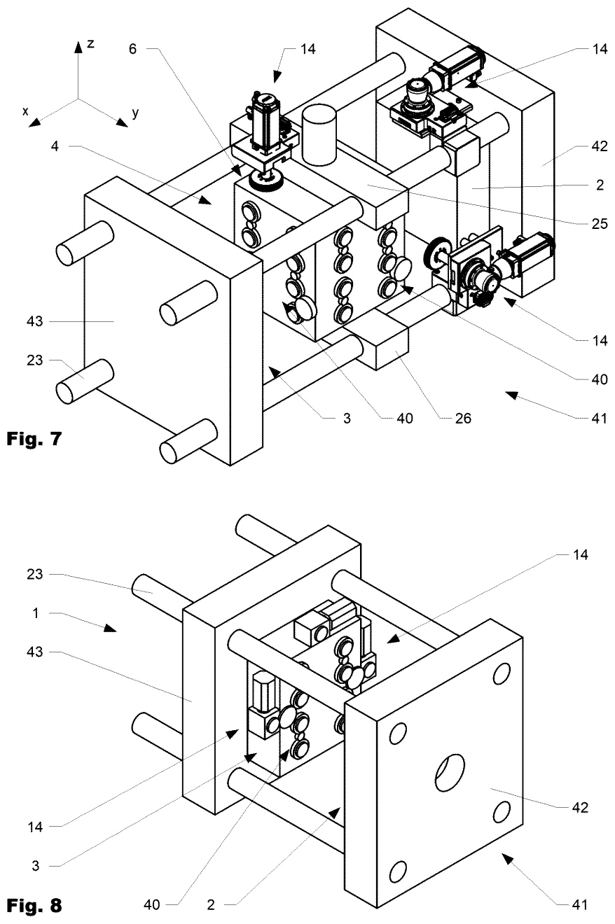

FIG. 6 is showing a variation of a drive unit 14 according to the present disclosure. The same drive unit 14 is shown in the previous Figures incorporated in an injection-molding device according to the disclosure. The drive unit 14 comprises an electric motor 33, which is attached to a thereto interconnected gearbox 34, respective the housing of the gearbox 34. The shown gearbox 34 is of an angular type and transfers the rotation of the motor axle by an angle of 90°. Depending on the field of application, other gearboxes and/or motors are possible. The drive unit 14 further comprises a platform 35 to which the gearbox 34 is attached. If appropriate, the platform 35 can be integrated into a housing of the gearbox 34. The platform 34 is attached to a bracket 36. By the bracket 36, the drive unit 14 can be easily attached (clamped) in different positions to a tie bar of an injection molding machine as shown in FIG. 7 and FIG. 8 in an explanatory manner. Alternatively or in addition to the bracket 36, the platform 35 can be attached to a mold half as shown in FIG. 7 and FIG. 8. The drive unit 14 further comprises an output gear 37. In the shown variation, the output gear 37 is integrated in the platform 35 and therefore only partially visible. The output gear 37 is a spur gear. It is foreseen to couple to an input gear of the injection molding device (see previous Figures) in axial or radial direction. Depending on the field of application, other output gears 37 are possible which are temporarily or permanently coupled. In the shown variation, the drive unit 14 further comprises a socket 38 by which the drive unit 14 can be interconnected to a power supply and/or a control unit (both not shown in detail). Furthermore, the drive unit 14 can comprise at least one sensor 39 to determine the position of the drive unit 14 with respect to other parts of the injection-molding device 1. In the shown variation, the sensor 39 is foreseen to measure a distance in a coupling direction (here x direction).

As e.g. visible in FIG. 7 and FIG. 8, the drive unit 14 can be attached directly to a displaceable second mold half or a stationary first mold half. In case of a stationary mold half the drive unit 14 alternatively or in addition can be clamped with respect to at least one tie bar 23 of an injection molding machine 41 of which only parts are shown in a simplified manner. In the case of a cube mold as shown in FIG. 7 which comprises an about a rotation axis rotatable center part 4, similar to the variation according to FIG. 1 through FIG. 5, the drive unit 14 can even be attached to a bearing block 24, 25 of the center part 4. In the shown variation, the drive unit 14 is attached to the upper bearing block 25, which is interconnected to the upper tie bars 23.

The drive unit 14 is preferably arranged on the outside of the first or the second mold half such that it remains accessible, e.g. from a lateral side of the injection mold, although the injection molding device 1 is in a closed position. Depending on the field of application, the drive unit 14 can be used to actuate other elements in molds, which have a single parting line and do not comprise a center block. The drive unit 14 can e.g. be used to actuate a turntable in an injection mold arranged in a closed position between a first and a second mold half. As visible in FIG. 7 on the lower right corner of the drawing, the drive unit 14 can be arranged on a platform 35 spaced a distance apart from a lateral side of the mold half 2. In the shown variation, the drive unit 14 is in addition attached by a bracket 36 to a tie bar 23 of the injection-molding machine 40. A drive unit 14 as described and shown can be used in many different ways. E. g. it can be used to drive at least one integrated unscrewing gear 41 for parts with internal or external threads on cube molds as schematically shown in FIG. 7 or single face molds as schematically shown in FIG. 8 or stack molds with more than one parting line. Depending on the field of application and the thereto respective design of the injection mold, more than one drive unit 14 can be foreseen as schematically shown in FIG. 7 and FIG. 8. The drive unit 14 should thus be considered a separate inventive concept, which may be made subject of one or several divisional patent applications.

Rather, the words used in the specification are words of description rather than limitation, and it is understood that various changes may be made without departing from the Spirit and scope of the disclosure.

LIST OF DESIGNATIONS

| | |
|---|---|
| 1 | Injection molding device |
| 2 | First (outer) mold half |
| 3 | Second (outer) mold half |
| 4 | Center part |
| 5 | Rotation axis (center block) |
| 6 | Center block |
| 7 | Side face |
| 8 | Inner cavity half (first and |
| | second) |
| 9 | Outer cavity half (first and |
| | second) |
| 10 | Cavity |
| 11 | Aligned position |
| 12 | Lateral position |
| 13 | Displaceable cavity section |
| 14 | Drive unit |
| 15 | Turntable |
| 16 | Rotation axis (turntable) |
| 17 | Actuation finger |
| 18 | First gear (turntable) |
| 19 | Second gear (drive unit) |
| 20 | Platform (turntable) |
| 21 | Dorsal position (platform) |
| 22 | Distal position (platform) |
| 23 | Tie bar |
| 24 | Holding device (center part) |
| 25 | Upper bearing block (center |
| | part) |
| 26 | Lower bearing block (center |
| | part) |
| 27 | Motor (center block) |
| 28 | Coordination device |
| 29 | Linear bearing |
| 30 | Guide rod |
| 31 | First parting line |
| 32 | Second parting line |
| 33 | Motor (drive unit) |
| 34 | Gearbox (drive unit) |
| 35 | Platform (drive unit) |
| 36 | Bracket (drive unit) |
| 37 | Output gear (drive unit) |
| 38 | Socket (drive unit) |
| 39 | Sensor (drive unit) |
| 40 | Unscrewing gear |
| 41 | Injection molding machine |
| 42 | Stationary mold fixing plate |
| 43 | Displaceable mold fixing |
| | plate |

1. Injection-molding device (1) for making of multi-component plastic products by injection molding of several components of plastic material, the injection molding device (1) comprising:
a. a first mold half (2) and a second mold half (3) displaceable with respect to each other in a first direction (x) between an open position and a closed position;
b. a center part (4) comprising an around a rotation axis (5) rotatable center block (6) with at least one pair of opposite side faces (7) each comprising at least one inner cavity half (8) in the open position being arranged rotatable in steps of 90° around the rotation axis (5) between the first mold half (2) and the second mold half (3) alternating between
i. an aligned position (11), forming in the closed position cavities (10) with corresponding outer cavity halves (9) arranged at the first mold half (2) and the second mold half (3), and
ii. a lateral position (12) accessible from the outside when in the closed position;
c. the at least one inner cavity half (8) comprising at least one in at least one direction displaceable cavity section (13)
d. a drive unit (14) configured to interact with the displaceable cavity section (13) arranged in the lateral position to move the displaceable cavity section (13) from a first position into a second position;
e. wherein the at least one displaceable cavity section (13) is arranged rotatable with respect to the side face (7) of the center block (6) in which it is arranged.

2. (canceled)

3. The injection-molding device (1) according to claim Error! Reference source not found., wherein the displaceable cavity section (13) is arranged on a turntable (15) rotatable around a rotation axis (16) extending perpendicular to the respective side face of the center block (6).

4. The injection-molding device (1) according to claim 0, wherein the displaceable cavity section (13) is arranged displaceable with respect to the turntable (15).

5. The injection-molding device (1) according to claim 4, wherein the displaceable cavity section (13) is actuated by at least one actuation finger (17) arranged at the center block (4).

6. The injection molding device (1) according to claim 3, wherein the turntable (15) comprises a first gear (18) to interconnect to a second gear (19) of the drive unit (14).

7. The injection molding device (1) according to claim 0, wherein the turntable (15) is with respect to the center block (6) arranged linearly displaceable in the direction of the rotation axis (16).

8. The injection molding device (1) according to claim 7, wherein the turntable (15) is arranged on a platform (20), said platform (20) being arranged linearly displaceable in the direction of the rotation axis (16).

9. The injection-molding device (1) according to claim 3, wherein two turntables (15) are arranged in a side face (7) adjacent to each other.

10. The injection-molding device (1) according to claim 1, wherein the displaceable cavity section (13) is arranged displaceable perpendicular to the respective side face (7) of the center block (6).

11. The injection molding device (1) according to claim 1, wherein the drive unit (14) is arranged in a fixed manner with respect to the first mold half (2) or the second mold half (3).

12. A drive unit (14) for an injection molding device (1) according to claim 1, said drive unit (14) being at least partially arranged on the outside of at least one mold half (2, 3) and being interconnected to a moveable device arranged at the at least one mold half (2, 3).

13. The drive unit (14) according to claim 12, wherein the drive unit (14) comprises a motor (33) and a gear box (34) which arranged on the outside of the at least one mold half (2, 3).

14. The drive unit (14) according to claim 0, wherein the motor (33) and the gear box (34) are arranged on a platform (35).

15. The drive unit (14) according to claim 0, wherein the drive unit (14) is attached by a bracket (36) to a tie bar (23) of an injection-molding device machine (40).

16. A method for production of complex plastic products comprising the following method steps:
a. Providing an injection molding device (1) according to any of the preceding claims;
b. Closing the injection molding device (1) by relative movement in the first direction (x) such that between the first mold half (2) and a thereto in the first direction aligned first side face (7) of the center block (6) at least one first cavity (10) is established by at least one first outer cavity half (9) and at least one first inner cavity half (8) and between the second mold half (3) and a thereto in the first direction aligned second side face (7) of the center block (6) at least one second cavity (10) is established by at least one second outer cavity half (9) and at least one second inner cavity half (8);
c. Injecting liquefied plastic material into the first and the second cavity (10) to form first and second parts;
d. Opening the injection molding device (1) and rotating the center part (4) by 90° such that the at least one first inner cavity half (8) and the therein arranged first part and the at least one second inner cavity half (8) and the therein arranged second part are moved to opposite lateral positions with respect to the center part (4);
e. Closing the injection molding device (1);
f. In the lateral position, on the side face (7) where the at least one first part is arranged in the first inner cavity half (8), interconnecting the drive unit (14) with the at least one displaceable cavity section (13) and moving the at least one first part from the at least one first inner cavity half (8) to the at least one second inner cavity half (8) by displacing the displaceable inner cavity section (13);
g. In the lateral position, on the side face (7) where the second parts are arranged in the at least one second inner cavity half (8), removing the second parts from the at least one second inner cavity half (8).
